(19) United States
(12) Patent Application Publication
(10) Pub. No.: US 2012/0275021 A1
(43) Pub. Date: Nov. 1, 2012

(54) DEPTH-ENHANCING SCREENS

(76) Inventors: Catherine Ansbro, Boyle (IE); Eamonn Ansbro, Boyle (IE); John Braithwaite, Dalserf (GB)

(21) Appl. No.: 13/520,666

(22) PCT Filed: Jan. 5, 2011
(86) PCT No.: PCT/US11/20220

§ 371 Date: Jul. 5, 2012

(30) Foreign Application Priority Data
Jan. 5, 2010 (EP) 10150130.2

(51) Int. Cl. G03B 21/56

(52) U.S. Cl. 359/451

(57) ABSTRACT

Depth-enhancing screens for producing a simulated 3D image. According to one aspect, the depth-enhancing screen comprises a Fresnel lens and the screen is adapted to be arranged adjacent an image source such that the Fresnel lens is arranged between the image source and a viewer and the optical centre of the Fresnel lens is offset from the geometric center of the screen. The screen may be formed from multiple overlaying Fresnel lens, which may different optical centers. The Fresnel lenses may be flat or curved along their height and/or width to form an apex in the central region.

### FIELD OF THE INVENTION

The present invention relates to depth-enhancing screens for producing an image having enhanced depth or a simulated three-dimensional effect.

### BACKGROUND TO THE INVENTION

Depth perception is the visual ability to perceive the world in three dimensions. Humans (and other animals) use a variety of monocular cues (that is, cues available from the input of just one eye) and binocular cues (that is, cues that require input from both eyes) to perceive depth.

Motion parallax is a type of monocular cue which affects depth perception. When an observer moves, the apparent relative motion of several stationary objects against a background gives hints about their relative distance. These subtle movements by the observer work in the real world for providing a better understanding of depth. However, when viewing images on a flat television or computer screen, such movements will not facilitate depth perception because there is no relative motion between objects shown in the two-dimensional image.

Stereopsis or retinal disparity is a type of binocular cue which affects depth perception. Information derived from different projection of objects on to each retina is used to judge depth. By using two images of the same scene obtained from slightly different angles, it is possible for the brain to calculate the distance to an object. If the object is far away, the retinal disparity will be small. On the other hand, if the object is close, the retinal disparity will be large. Again, this effect works in the real world to give a viewer a better understanding of depth, but does not work with a flat two dimensional screen because all objects on the screen appear to be at the same distance from the viewer.

Stereoptic effect may, however, be used to “trick” the brain into perceiving depth in a two dimensional image, such as a “Magic Eye” picture or a stereoscopic photo. Similarly, stereoptic effect may be used to produce a simulated three-dimensional image (that is, an image having depth cues) from a two-dimensional image such as an image on a flat television or computer screen, as described in our European Patent Application Publication No. EP1 636 631. This document describes an apparatus comprising a flexible Fresnel lens curved in two transverse directions so as to create a substantially convex lens. The apparatus may be mounted, for example, in front of a television screen or computer monitor 2 as shown in FIG. 1 to produce a simulated three-dimensional image of the two-dimensional image displayed on the screen. The Fresnel lens 3 is spaced apart from the screen 2 and is curved in a first plane (the x-z plane) and a second plane (the y-z plane) so as to form a Fresnel lens having two planes of curvature. As shown in the drawing, if a cross-section of the lens were taken in the x-z plane, the cross-section of the lens would be curved or arcuate in shape across its entire width. Similarly, if a cross-section were taken in the y-z plane, the cross-section would also be curved or arcuate in shape. As the x- and y-planes are, by definition, orthogonal to one another, there are thus two orthogonal planes in which the lens is arcuate in cross-section. The Fresnel lens may be flexible and positioned within a mount configured with adjustable tensioning members so as to tune the optical characteristics of the Fresnel lens so as to optimise production of the simulated three-dimensional image. Because the Fresnel lens is curved in two transverse planes, slightly different images are received by the left and right eyes of the viewer, producing a stereoptic effect, which is interpreted by the brain so that the image appears to have depth, that is, the image appears more three-dimensional than would otherwise be the case.

Our European Patent Application Publication No. 2 048 522 describes a depth-enhancing screen for producing a simulated 3D image, comprising a multi-curved Fresnel lens which when viewed in cross-section along the or each longest line linking two points on the edge of the lens, has a curved cross-section with an apex in the central region of the lens, and wherein each end of the curve flattens before it reaches the edge of the lens.

However, a disadvantage associated with the depth-enhancing screens as described in each of the above-referenced documents is that the curved Fresnel lens may cause reflections which cause a deterioration of the image quality as perceived by the viewer.

The present invention is directed to overcoming, or at least reducing or altering, the undesired effects of, reflection caused by the curved Fresnel lens.

A further disadvantage relates to the use of the depth-enhancing screens described above with small image sources or screens. With small image sources, the enhanced effect may be minimal, or even absent where the width of the source screen is smaller than the viewer's inter-pupillary distance. The present invention is also directed to improving the effect of depth perception for image sources and screens.

### SUMMARY OF THE INVENTION

According to an aspect of the invention, there is provided a depth-enhancing screen for producing a simulated 3D image, comprising:
a Fresnel lens;
characterised in that the screen is adapted to be arranged adjacent an image source, such that the Fresnel lens is arranged between the image source and a viewer and the optical centre of the Fresnel lens is offset from the geometric centre of the lens. In one embodiment, there may be two Fresnel lenses in laminar arrangement. They may both be positive, both negative, or one positive and one negative. Also, optionally, they may have optical centers offset from each other. They may also have different focal lengths.

A positive Fresnel lens is one that causes incident parallel rays to converge at a focal point on the opposite side of the lens, i.e. a converging lens. A negative Fresnel lens is one that causes incident parallel rays to emerge from the lens as though they emanated from a focal point on the incident side of the lens, i.e. a diverging lens.

By laminar arrangement, it is meant that the Fresnel lenses are arranged as parallel layers, that is, one in front of the other, so that light rays from the image source pass through both lenses. The laminar arrangement may be a spaced-apart parallel relationship, or the lenses may be contact with one another.

With multiple Fresnel lenses, they may be substantially planar or both may be curved in the directions of multiple axes. When they are substantially planer, reflections are reduced. A further advantage of this arrangement is that the viewing angle of the depth-enhancing screen, that is, the angle at which the viewer may perceive the depth-enhanced effect, may be increased as compared with existing screens. Also, when multiple Fresnel lenses are employed, the negative Fresnel lens may be adjacent the image source and the positive Fresnel lens may be closer to the viewer, or vice versa.

As is well known in the art, a Fresnel lens is smooth on one side (“unlensed side”) and comprises a plurality of grooves and ridges on the other side (“lensed side”). In embodiments employing multiple Fresnel lenses, the lenses may be oriented in any configuration, that is, the unlensed sides of the lenses may be oriented towards one another, or the lensed sides of the lenses may be oriented towards one another, or the lensed side of one lens may be oriented towards the unlensed side of the other lens. In embodiments where the unlensed sides of the lenses are oriented towards one another, the two lenses may be integrally formed on a single substrate. The substrate may be thick enough to accommodate the groove depth required for each lens.

In one embodiment, the lenses are arranged such that the lensed sides of both lenses are oriented towards the viewer. In another embodiment, the negative Fresnel lens is also arranged adjacent the image source and the positive Fresnel lens is arranged closer to the viewer. This arrangement may enhance maximum viewing angle and image quality.

In another embodiment, the lenses may be connected to one another, directly or indirectly. In one embodiment, the screen further comprises a frame and the lenses are mounted in the frame such that they are in contact with one another. In another embodiment, the lenses are connected to one another by means of an optical bonding agent, which may be applied over the entire lens surface, or a portion thereof, for example, at one or more edges or corners. An optical bonding agent may comprise, for example, UV curing glue or Canada balsam bonding agent.

In one embodiment, the screen further comprises a medium interposed between the lenses. The medium may comprise a fluid, such as air or another gas or liquid such as nitrogen, or optical bonding agent. In a further embodiment, the screen further comprises one or more optical elements in laminar arrangement with the lenses. The optical elements may be interposed between the lenses. The optical element may include one or more transmissive optical components, such as a polarizing filter, a optical lens, a clear optical window such as one made of acrylic, a diffraction grating, holographic grating or replica grating.

The grooved or lensed side of a Fresnel lens comprises a plurality of circular or part circular grooves, such that the grooves share a common centre of origin. The optical centre of a Fresnel lens is defined as the point of centricity of the grooves which make up the Fresnel lens. In one embodiment of the invention, the optical centres of the lenses are offset from one another, that is, the optical centres of the lenses are not aligned. In one embodiment, the optical centre of each lens is offset from the geometric centre of the screen (or image source) in different directions. Thus, the depth-enhancing screen may be adapted to be arranged adjacent the image source such that the optical centre of each of the Fresnel lenses is offset from the geometric centre of the image source in a different direction. In another embodiment, one Fresnel lens may be arranged so as to be centred on the image source, while another Fresnel lens is offset from the centre of the image source. When a curved lens is used, its optical centre may be displaced from the geometric centre of the image source.

Some arrangements described herein may be advantageous for small images sources, such as small LCD or LED screens on mobile telephones, personal digital assistants, personal game consoles etc. The term “small” is used herein to refer to image sources that have at least one dimension which is shorter than, or near to, the inter-pupillary distance of the viewer. Typical inter-pupillary distance for adults is around 54 to 68 mm, while measurements generally fall between 48 and 73 mm For children the measurement usually ranges from 41 to 55 mm One embodiment has application in screens having at least one dimension of about 70 mm or less. Offsetting the optical centre of the Fresnel allows the left and right eyes of the viewer to receive rays that are further apart than they would otherwise be, thereby enhancing the perception of depth in the image. This arrangement is also useful in reducing or desirably altering reflections or distortion from the depth-enhancing screen, particularly at the corners.

In one embodiment, the optical centre of the Fresnel lens is offset from the geometric centre of the Fresnel lens, that is, the optical centre of the Fresnel lens is not co-incident with its geometric centre. The offset may be introduced during manufacture of the lens. For example, the lens may be cut so that its optical axis is offset from its geometric centre. In other embodiments, the tool or mold used to manufacture the Fresnel lens may be adapted such that the optical centre of the manufactured lens is offset from its geometric centre. Alternatively, or additionally, the Fresnel lens may be mounted in a frame for attachment to the image source, such that the optical centre of the lens is offset from the geometric centre of the frame. In all cases, the single Fresnel lense—or, if more than one Fresnel lens is used, one or both Fresnel lenses—are meant to be viewed by both eyes of the viewer.

In one embodiment, the depth-enhancing screen comprises a plurality of Fresnel lenses, wherein the depth enhancing screen is adapted to be arranged adjacent the image source such that each of the plurality of Fresnel lenses is arranged between the image source and the viewer and the optical centre of at least one of the Fresnel lenses is offset from the geometric centre of the image source.

The optical centre of one or more of the Fresnel lenses may be offset from the geometric centre of the image source by the same distance or by different distances. The optical centre of each of the Fresnel lenses may also be offset from the geometric centre of the image source in a different direction.

In another embodiment a first Fresnel lens may have is concentric grooves that a spaced by a distance different than the concentric grooves of a second Fresnel lens; in other words, the two lenses have different groove pitches.

According to one embodiment of the depth-enhancing screen the Fresnel lens is a multi-curved Fresnel lens which when viewed in cross-section along the or each longest line linking two points on the edge of the lens, has a curved cross-section with an apex in a central region of the lens; and the optical centre of the Fresnel lens is offset from the apex in the central region of the lens. The term “longest line” when used herein is intended to mean the longest straight line on the surface of the lens when the lens is flat. Such a screen may be considered curved along its height and width.

Properties of the Fresnel lens, such as size, focal length and groove pitch may be selected based on the intended application of the particular depth-enhancing screen. The optimal magnitude of the offset may be determined based on the size of the Fresnel and the intended application. Optimal offsets are typically between 0.1% and 5% of the width (or diameter) of the Fresnel lens. The optimal offset decreases as the size of the selected Fresnel lens increases. Typically, the offset may be of the order of 5 to 20 grooves. Thus, the magnitude of the offset depends on the number of grooves per millimetre in the selected lens (groove pitch). These same techniques may also be used with lens arrays, e.g. sheets comprising multiple micro-Fresnel lenses.

According to another aspect of the invention, there is provided a depth-enhancing screen for producing a simulated 3D image, comprising:
a Fresnel lens, having a lensed side and a non-lensed side;
characterised in that the screen is adapted to be arranged adjacent an image source, such that the Fresnel lens is arranged between the image source and a viewer to with the lensed side oriented towards the viewer.

One advantage associated with this arrangement is that it reduces or desirably alters reflections or distortions from the depth-enhancing screen, thereby improving the quality of the image seen by the viewer, or thereby achieving a desired special affect (e.g., if distortion is desired for advertising purposes to achieve a certain effect). A further advantage of this arrangement is that the viewing angle of the depth-enhancing screen, that is, the angle at which the viewer may perceive the depth-enhanced effect, is increased as compared with existing screens.

The depth-enhancing screen may comprise a plurality of Fresnel lenses, wherein one or more of the lenses is arranged such that the lensed (grooved) side is oriented towards the viewer.

According to another aspect of the invention, there is provided a depth-enhancing screen for producing a simulated 3D image, comprising:
a multi-curved Fresnel lens which when viewed in cross-section along the, or each, longest line linking two points on the edge of the lens, has a curved cross-section with an apex in a central region of the lens;
characterised in that the screen is adapted to be arranged adjacent an image source, such that the Fresnel lens is arranged between the image source and a viewer and such that the curvature of the lens is concave towards the viewer, that is, the central portion of the lens curves away from the viewer.

This arrangement may reduce reflections from the depth-enhancing screen, thereby improving the quality of the image seen by the viewer. Also, the depth-enhancing screen, that is, the angle at which the viewer may perceive the depth-enhanced effect, may be increased as compared with existing screens.

The depth-enhancing screen may further comprise means for adjusting the curvature of the Fresnel lens, wherein adjusting the curvature of the lens varies the amount of depth-enhancement experienced by the viewer and the viewing angle at which the depth-enhancement may be perceived. Any means of adjusting the curvature of the lens may be used, including mechanical, electro-mechanical, or other methods, such as manufacturing the lens in such a way that it is curved during the manufacturing process (e.g. some compression molding techniques in which the lens is removed in a curved configuration). The Fresnel lens may be formed from a flexible material, such that the curvature of the lens may be adjusted or tuned

According to several aspects of the invention set out above, there is provided a depth-enhancing screen comprising a multi-curved Fresnel lens which when viewed in cross-section along the or each longest line linking two points on the edge of the lens, has a curved cross-section with an apex in a central region of the lens. In embodiments of the invention, each end of the curve flattens before it reaches the edge of the lens. The term “flattens” when used herein is intended to mean approaching but not necessarily reaching flat, although the edge of the lens may reach flat. Preferably the ends of the curved cross-section are curved, but the degree of curvature of the cross-sectional curve decreases towards the ends, i.e. the radius of curvature at the ends is less that the radius of curvature approaching the apex. Preferably the difference in the degree of curvature is considerable.

In these embodiments of the invention, the lens may have a curved cross-section when viewed in cross-section along a second line substantially perpendicular to the longest line, the second curve having an apex in the central region of the lens. Each end of the second curve may flatten before it reaches the edge of the lens. For example, the Fresnel lens may be oval in shape when flat wherein the longest line is the oval's major axis and the second line is the oval's minor axis.

It will be appreciated that, in these embodiment, the Fresnel lens therefore has at least two primary curvatures, wherein the primary curvatures are arranged such that there are at least two planes transverse to one another in which the cross section of the Fresnel lens is arcuate in shape.

The primary curvatures in the lens are arranged such that there are two intersecting or transverse planes in which the lens has an arcuate or curved cross-section. These planes may be orthogonal (or substantially orthogonal), that is, at right angles to one another. There may be several transverse or intersecting planes in which the lens has a curved cross-section. The primary curvatures may be arranged in a similar manner as described above with reference to FIG. 1.

The surface of the lens may be described as substantially dome or “cushion” shaped, depending on the number of primary curvatures introduced. As an example, in one embodiment where the lens is square in shape when flat, the centre or central region of the lens lies in a first plane (parallel to the x-y plane shown in FIG. 1), with the corner regions of the lens lying in a common second plane, parallel to but spaced apart from the first plane. Each edge of the lens is therefore curved, with the apex equidistant between the two corners. The apex of the edge lies in a third plane, parallel to but lying between the first and second planes. The unconstrained corners of the lens may lie in the second plane or may lie in a further parallel plane.

### BRIEF DESCRIPTION OF THE DRAWINGS

FIG. 1 is a perspective view of a prior art optical system showing a two-axis curvature of a Fresnel lens;

FIG. 2 is an exploded isometric view of a depth-enhancing screen according to a first embodiment;

FIG. 3 is a side elevation view of the depth-enhancing screen of FIG. 2;

FIG. 4a is a front view of a first Fresnel lens screen having an optical center in the geometric center of the lens;

FIG. 4b is a front view of a second Fresnel lens screen having an optical center offset from the geometric center of the lens;

FIG. 5 is a side cross section view of a depth-enhancing screen having two flat abutting Fresnel lenses;

FIG. 6 is a side cross section view of a depth-enhancing screen having two flat abutting Fresnel lenses and an intermediate medium.

FIG. 7 is a side cross section view of a depth-enhancing screen having two curved abutting Fresnel lenses.

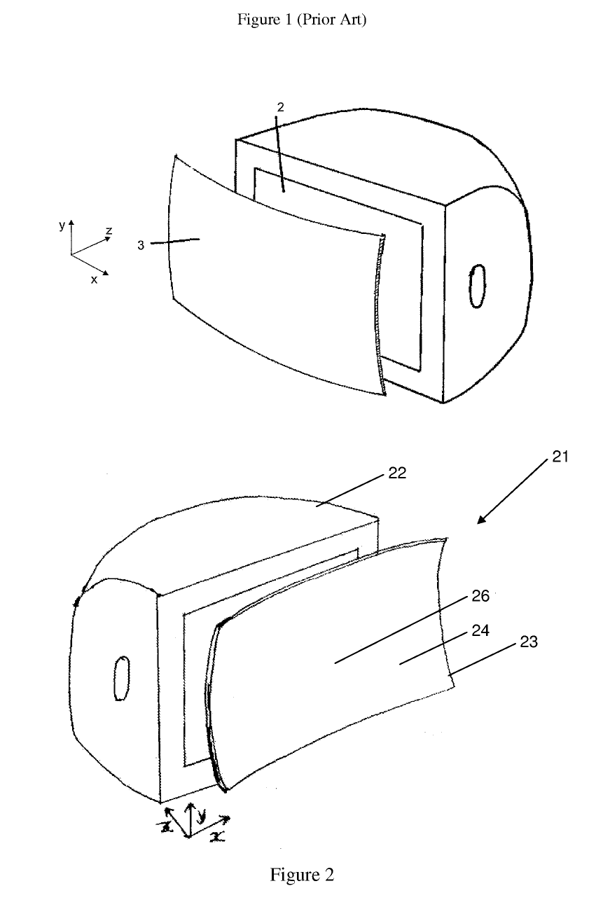

### DETAILED DESCRIPTION OF THE DRAWINGS

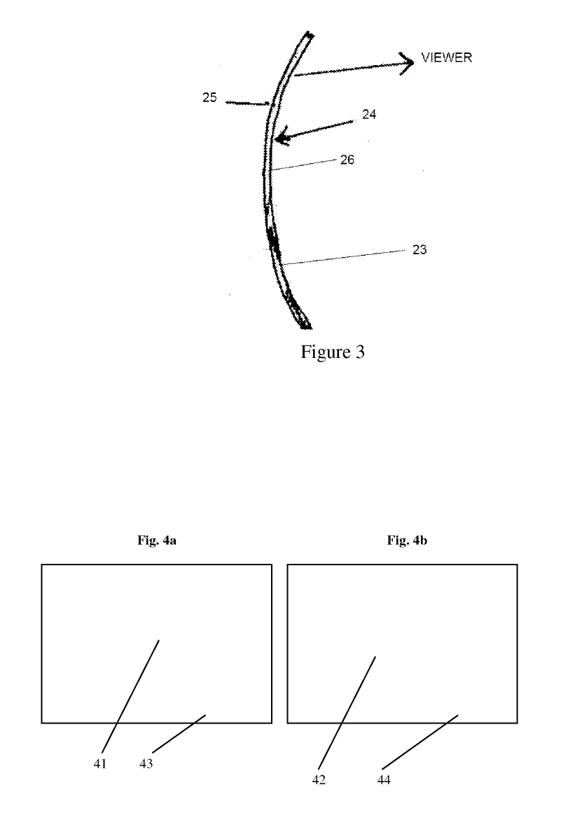

Referring to FIGS. 2 and 3 of the drawings, there is illustrated a depth-enhancing screen 21. The screen 21 may be mounted in front of an image source, for example, a television screen or computer monitor 22, to produce a simulated three-dimensional image of the two-dimensional image displayed on the television screen 22. The depth-enhancing screen 21 comprises a Fresnel lens 23, having a lensed (grooved) side 24 and a non-lensed (smooth) side 25. In one embodiment, the Fresnel lens is arranged between the image source 22 and a viewer with the lensed side 24 oriented towards the viewer. Furthermore, the Fresnel lens 23 is a multi-curved Fresnel lens which when viewed in cross-section along the or each longest line linking two points on the edge of the lens, has a curved cross-section with an apex in a central region 26 of the lens. In the embodiment shown, the curvature of the lens is concave towards the viewer, that is, the central portion 26 of the lens curves away from the viewer.

In an embodiment shown in FIG. 3, the optical centre of the Fresnel lens 23 may be offset from the geometric centre 26 of the lens. This is particularly useful for small computer screens, such as those found on handheld devices.

According to various embodiments of the invention, the Fresnel lens 22 may be flexible and positioned within a mount configured with adjustable tensioning members so as to tune the optical characteristics of the Fresnel lens so as to optimise the viewing angle and the perception of depth by the viewer, such as those disclosed in European Patent Application Publication No. EP1 636 631 or 2 048 522.

The curvature of the lens is substantially uniform across the height and width and of the lens.

In one embodiment, the screen may be comprised of two Fresnel lenses that are laminated together. As shown in FIGS. 4a and 4b, the first lens 43 may have an optical center 41 (the center of the circular grooves comprising the Fresnel lens) that differs than the optical center 42 of second lens 44. In one embodiment, the amount of displacement may be five grooves of the lens, but the amount displacement is generally selected based on the desired results, the size of the screen, and the typical distance between the screen and the viewer. Either lens may be either a positive Fresnel lens or a negative Fresnel lens.

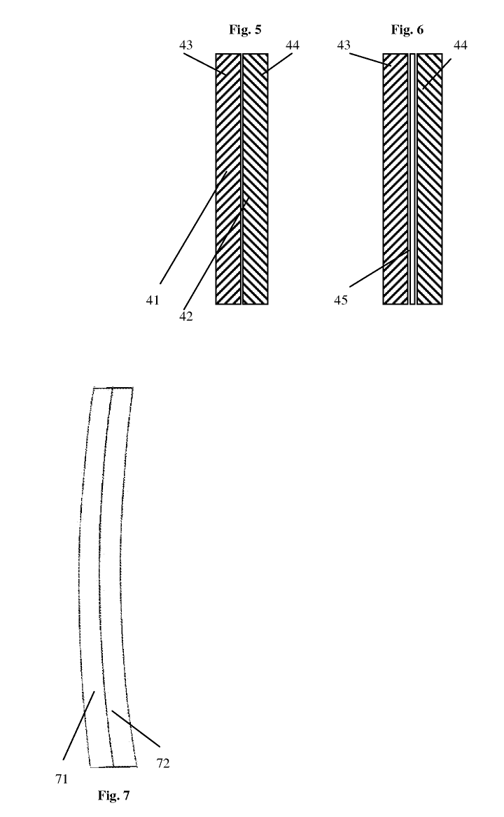

A side cross sectional view of a screen comprised of two laminated abutting Fresnel lenses, 43 and 44, is shown in FIGS. 5 and 6. As used herein, the term abutting means that a first Fresnel lens substantially overlays a second Fresnel lens, so that the image seen by a viewer passes though both Fresnel lenses. As shown in FIG. 5, the optical center 41 of lens 43 is in the geometric center, while the optical center of lens 44 is not. In FIG. 6, the lenses 43 or 44 are separated by a medium, as described above. Optionally, such a medium may include an optical grating which may marginally enhance the depth effect and modify false color. Other options for the medium include a polarizing filter, a lens, a clear acrylic window, a diffraction grating or a replica grating. Also, optionally, an anti-reflection window may be laminated or applied to the side of the Fresnel lens closest to the viewer.

In the multiple Fresnel lens embodiments, the grooved sides of each Fresnel lens may be oriented toward the viewer, and the flat side of each Fresnel lens may be oriented toward the image source. Alternatively, the lenses may have the flat sides oriented towards the viewer, or one may have its flat side towards the viewer and another may have the grooved side towards the viewer. In the multiple Fresnel lens embodiments, the optical characteristics and focal lengths of the respective lenses may be selected based on the application. For example, the different characteristics would be selected for a screen to be applied to a hand-held video game that would be viewed at a close distance, as compared to a billboard or stadium jumbo screen that would be viewed from a far distance. In general, for larger screens that are viewed from greater distances, it will be desirable to utilize Fresnel lenses with greater focal lengths. Representative characteristics for a 100 mm screen are as follows, it being understood that the 100 mm distance refers to the longest axis of opposing sides of a screen. This would the diameter for a circular screen, or a diagonal for a rectangular screen. In one embodiment, if two positive Fresnel lens are used, the first Fresnel lens may have a focal length of +/−40% that of the second positive Fresnel lens. For example, the if the screen size is 100 mm, the first positive Fresnel lens may have a +100 mm focal length, and the second positive Fresnel lens may have a +70 mm focal length. In another embodiment, for a 100 mm screen, a positive Fresnel lens may have a +100 mm focal length, while a negative Fresnel lens may have a −170 focal length. If two negative Fresnel lens are used, the first Fresnel lens may have a focal length of +/−40% that of the second negative lens. For example, the if the screen size is 100 mm, the first negative Fresnel lens may have a −100 mm focal length, and the second negative Fresnel lens may have a −65 mm focal length.

The words “comprises/comprising” and the words “having/including” when used herein with reference to the present invention are used to specify the presence of stated features, integers, steps or components but does not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

1. A depth-enhancing screen having a geometric center for producing a simulated 3D image, comprising:
a multi-curved Fresnel lens which when viewed in cross-section along each longest line linking two points on the edge of the lens, has a curved cross-section with an apex in a central region of the lens;
and wherein the optical centre of the Fresnel lens is offset from the apex in the central region of the lens;
and wherein the screen is adapted to be arranged adjacent an image source such that the Fresnel lens is arranged between the image source and a viewer.

2. A depth-enhancing screen as claimed in claim 1, comprising a plurality of abutting Fresnel lenses, wherein the screen is adapted to be arranged adjacent the image source such that each of the plurality of Fresnel lenses is arranged between the image source and the viewer and the optical centre of at least one of the Fresnel lenses is offset from the geometric center of the screen.

3. A depth-enhancing screen as claimed in claim 2, wherein the optical center of two or more of the Fresnel lenses is offset from the geometric center of the screen.

4. A depth-enhancing screen as claimed in claim 3, wherein the optical center of each of the Fresnel lenses is offset from the geometric center of the screen by a different distance.

5. The depth-enhancing screen as claimed in claim 2, wherein each Fresnel lens has a lensed side and a non-lensed side and the screen is adapted to be arranged such that the lensed side of the Fresnel lens is oriented towards the viewer.

6. The depth-enhancing screen as claimed in claim 2, further comprising a light transmissive medium between each abutting Fresnel lens.

7. A depth-enhancing screen having a geometric center for producing a simulated 3D image, comprising:
first and second abutting Fresnel lens, each lens having a lensed side and a non-lensed side;
wherein the screen is adapted to be arranged adjacent an image source such that each Fresnel lens is between the image source and a viewer with the lensed sides oriented towards the viewer.

8. A depth-enhancing screen as claimed in claim 7, wherein the optical center of at least one of the Fresnel lenses is offset from the geometric center of the screen.

9. A depth-enhancing screen as claimed in claim 7, wherein the first and second Fresnel lens have different focal lengths.

10. A depth-enhancing screen as claimed in claim 9, wherein the first Fresnel lens has a positive focal length and the second Fresnel lens has a negative focal length.

11. A depth-enhancing screen as claimed in claim 7, wherein the screen is flat.

12. A depth-enhancing screen as claimed in claim 7, wherein the screen is curved along its height and width to form an apex in its central region.

13. A depth-enhancing screen as claimed in any of claims 1 to 6 or 12, further comprising:
means for adjusting the curvature of the screen.
